(19) United States
(12) Patent Application Publication
(10) Pub. No.: US 2023/0304774 A1
(43) Pub. Date: Sep. 28, 2023

(54) Anti-Ballistic Barriers and Doors

(71) Applicant: John B. Adrain, Spokane, WA (US)

(72) Inventor: John B. Adrain, Spokane, WA (US)

(21) Appl. No.: 17/979,680

(22) Filed: Nov. 2, 2022

Related U.S. Application Data
(63) Continuation-in-part of application No. 17/006,442, filed on Aug. 28, 2020.
(60) Provisional application No. 63/274,826, filed on Nov. 2, 2021.
(60) Provisional application No. 63/017,563, filed on Apr. 29, 2020.
(60) Provisional application No. 62/929,467, filed on Nov. 1, 2019.
(60) Provisional application No. 62/911,323, filed on Oct. 6, 2019.
(60) Provisional application No. 62/895,734, filed on Sep. 4, 2019.
(60) Provisional application No. 62/892,899, filed on Aug. 28, 2019.

(51) Int. Cl. F41H 5/007; F41H 5/013; F41H 5/04; B32B 7/09; B32B 27/36; B32B 27/12; B32B 27/32

(52) U.S. Cl. CPC F41H 5/007; B32B 7/09; B32B 27/12; B32B 27/32; B32B 27/365; F41H 5/013; F41H 5/0407; F41H 5/0471; F41H 5/24

(57) ABSTRACT

An kinetic object protection system for protecting a space in a building or vehicle comprising a protective barrier including one or more sheets of a laminated material having a plurality of layers of lightweight, flexible, ballistic resistant material such as woven sheets, nets, or mesh which are secured together using a glue, heat weld, or stitching. The system may include an automated control system operably configured to cause a change in state of the barrier from a retracted state to a protective deployed state, which may include a sensing system operably configured to detect a threatening event, wherein the sensing system upon sensing the threatening event triggers the barrier to transition from the retracted state to the deployed protective state such that in the protective state, the barriers are adapted to be resistant to penetration by the kinetic objects such as vehicles.

### CROSS-REFERENCES TO RELATED APPLICATIONS

This application is a continuation-in-part to U.S. Application Serial No. 17/006,442 filed on Aug. 28, 2020, which claims the benefit of U.S. Provisional Application No. 62/892,899 filed on Aug. 28, 2019; U.S. Provisional Application 62/911,323 filed on Oct. 6, 2019; U.S. Provisional Application 62/895,734 filed on Sep. 4, 2019; U.S. Provisional Application 62/929,467, filed Nov. 1, 2019; and U.S. Provisional Application 63/017,563, filed on Apr. 29, 2020; all incorporated herein by reference. This application also claims the benefit of U.S. Provisional Pat. Application serial number 63/274,826 filed on Nov. 2, 2021, also incorporated herein by reference.

This application incorporates all of the material disclosed in US Pat. App. No.16/215,162, and its parent applications U.S. Pat. Application No. 15/050,639 filed on Feb. 23, 2016 which is a continuation-in-part of U.S. Pat. Application No. 14/476,206 filed on Sep. 3, 2014, which claims the benefit of U.S. Provisional Application No. 61/873,073, filed on Sep. 3, 2013, and also claims the benefit of U.S. Provisional Application No. 62/119,510 filed on Feb. 23, 2015, all of which are incorporated herein by reference in their entirety.

### BACKGROUND

This application relates generally to anti-ballistic barriers and anti-vehicle and anti-personnel barriers that can be provided in buildings, vehicles, and other items and locations to add anti-ballistic properties to those items and locations in order to protect a space from a kinetic object that may be of substantial mass.

Conventional approaches for protection against moving objects having substantial kinetic energy, such as vehicles, running personnel, rockets, bullets and/or shrapnel, involve the use of heavy, rigid materials that are fixed in place and provide a barrier based on their rigidity, heft, and strength. However, such items often transmit the energy of the projectiles through the material into the item or location being protected, or because the energy is not properly dissipated, the projectile may still have sufficient energy to penetrate the barrier in a dangerous manner, or because of the heavy weight the barrier cannot be quickly deployed.

Needed is a way to better absorb the kinetic energy of the undesired object to avoid penetration or other transmission of the energy to the item or person or space being protected.

Also needed is a way to re-enforce the strength of doors and other barriers against vehicle or other personnel using lightweight but strong materials.

### SUMMARY

Provided are a plurality of example embodiments, including, but not limited to, a barrier that is free to flex and move when struck by a kinetic object, said barrier for protecting an interior of a building, a region within or around a building, a vehicle, an outdoor space, or an individual.

Further provided is a system for protecting a space from entry by prohibited kinetic objects of substantial mass using a deployable barrier, comprising: a mounting structure configured for storing the deployable barrier in a retracted position; the deployable barrier comprising a plurality of sheets of flexible anti-ballistic material formed into a laminate; a structure for securing the sides and/or bottom of the deployable barrier to secure said deployable barrier in a deployed position; and a deployment mechanism configured to drop the deployable barrier into the deployed position such that the barrier protects the space from entry by prohibited kinetic objects having substantial kinetic energy.

Also provided is a system for protecting a space from entry by prohibited kinetic objects of substantial mass using a deployable barrier, comprising: a mounting structure configured for storing the deployable barrier in a retracted position; the deployable barrier comprising a plurality of sheets of flexible anti-ballistic material formed into a laminate, wherein said barrier is configured to flex and move in response to impact from the kinetic object to absorb energy from the kinetic object to further protect said space from access by the ballistic object; a structure for securing the sides and/or bottom of the deployable barrier to secure said deployable barrier in a deployed position; and a deployment mechanism configured to drop the deployable barrier into the deployed position such that the barrier protects the space from entry by prohibited kinetic objects having substantial kinetic energy.

Still further provided is a system for protecting a space from entry by moving vehicles using a deployable barrier, comprising: a mounting structure configured for storing the deployable barrier in a retracted position; the deployable barrier comprising a plurality of sheets of flexible anti-ballistic material formed into a laminate, wherein said barrier is configured to flex and move in response to impact from the moving vehicle to absorb energy from the kinetic object to further protect said space from access by the ballistic object; a structure for securing the sides and/or bottom of the deployable barrier to secure said deployable barrier in a deployed position; and a deployment mechanism configured to drop the deployable barrier into the deployed position such that the barrier protects the space from entry by moving vehicle.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 illustrates an example of a generic barrier.

FIG. 1A illustrates another example of a generic barrier.

FIG. 2 illustrates another example of a generic drop-down barrier.

FIG. 3A illustrates an example side cut view of a laminated structure for a barrier that provide both decorative and anti-ballistic features;

FIG. 3B illustrates another example side cut view of a laminated structure for barriers that provide a plurality of layers stitched together;

FIG. 3C illustrates another example side cut view of a laminated structure for barriers that provide a plurality of layers having a hollow interior;

FIG. 3D illustrates still another example side cut view of a of an anti-ballistic laminated structure attached to another base layer structure for acting in concert as a barrier;

FIG. 3E shows an alternative structure of the solution of FIG. 3D;

FIG. 3F shows still another alternative structure of the solution of FIG. 3D;

FIG. 4 illustrates an example embodiment of a deployable barrier with another separately deployable system;

FIG. 5 illustrates an example embodiment of a barrier system including a speaker/vibrator;

FIG. 6 illustrates an example embodiment of a barrier system reinforcing a door or other barrier;

FIG. 7 illustrates an example control system for an automated, deployable barrier system;

FIG. 8 illustrates an example embodiment of a networked system for integrating an automated deployable barrier system with smart speakers and other protective systems; and

FIG. 9 illustrates an example expanded network of connectivity to neighborhoods.

### DETAILED DESCRIPTION OF THE EXAMPLE EMBODIMENTS

There are various proposals for improving ballistic protection of individuals and interior spaces in buildings and vehicles as discussed in the related patent applications listed at the beginning of this application. The inventor has discovered that a problem with many current solutions to these problems is that the protection devices don’t absorb much of the energy that is contained in the ballistic projectiles, such as shrapnel or bullets that have been fired, or objects of relatively large kinetic energy, such as vehicles, rockets, missiles, or running personnel. The inventor has determined that one solution to this problem is to allow the protective device, such as a screen, panel, shroud, blind, or other barrier to hang freely, perhaps in a weighted manner, which allows the barrier to flex, vibrate, flow, sway and otherwise move in response to receiving the projectile, thereby dissipating some of the energy from the projectile that otherwise would remain as kinetic energy. This reduces the amount of damage and potential penetration of the projective with respect to a given amount of projection. Alternatively, the barrier may be secured on a portion of its periphery, such as along sides or a bottom (to avoid pushing aside the barrier), while allowing the main body of the barrier to flex to absorb kinetic energy.

As shown in U.S. Pat. App. No.16/215,162 and its related parents, all incorporated herein by reference, various deployable barriers using non-metallic anti-ballistic materials can be formed for use as barriers, such as window blinds and similar barriers that might be provided at various locations in buildings. Use in windows, doorways, hallways, and other interior locations as a deployable barrier that is stowed when not needed provides a way to protect various interior spaces within buildings. Furthermore, barriers can be provided within vehicles in either deployable or fixed manners (or both). Deployable barriers might be used to protect vehicle windows, doorways, hatches, and other access points, whereas permanently deployed barriers could be provided within vehicle voids such as in doors, body panels, and other locations.

Of particular interest are barriers that are lightweight and flexible in nature but that can absorb a substantial amount of kinetic energy from moving objects of substantial mass.

In some embodiments, the barriers may hang freely, not being fixed on their sides and bottoms, but that may include weights to increase their overall mass. Such barriers are free to flex and move in response to receiving a ballistic projectile, thereby converting at least a portion of the kinetic energy of the projectile into kinetic and heat energy in the barrier distributed across the entire surface area of the barrier. Allowing this free motion actually increases the effectiveness of the barrier by reducing the penetration energy of the projectile, thereby effectively improving the ability of the barrier to protect the desired person and/or interior region.

Of additional interest for at least some other embodiments are barriers that are still designed to flex and move in interior portions, but that are fixed on their sides and/or bottoms (i.e., fixed around a perimeter or portion thereof) in order to add additional stability and strength, such as to prevent a person or large object from entering a protected region. Such barriers are still free to flex and move in response to receiving a ballistic projectile in at least portion of their surface area, thereby converting at least a portion of the kinetic energy of the projectile into kinetic and heat energy in the barrier distributed across the entire surface area of the barrier. However, along with a fixed top, the fixed sides and/or bottom prevent individuals or objects from bypassing or pushing aside the barrier to get into the protected region. Hence, only the perimeter, or a portion of the perimeter, is fixed and secured, whereas an interior portion of the barrier is free to flex, vibrate, and otherwise kinetically absorb the energy of a ballistic projectile impinging on the barrier.

Finally, of interest are also barriers that are stiff and durable, but that are lightweight by using the lightweight, but strong and durable anti-ballistic materials and procedures disclosed herein. Doors, shutters, and other types of barriers can be provided using such materials that provide both anti-ballistic protection, and that can protect spaces from undesirable entry by persons, vehicles, and other objects that might attempt access into the protected spaces. In particular, a barrier that can stop a speeding vehicle or strongly thrown or launched object having substantial kinetic energy is desired.

Furthermore, fiber cables or ropes or twines could be formed using threads or fibers made of any of the disclosed lightweight antiballistic materials, which can be used for strength re-enforcement purposes while maintaining light weights.. Such ropes/cables could be used to strengthen any blinds, shutters, doors, or other barriers against penetration from larger objects such as vehicles, people, tools, etc. These materials could also be formed into mesh sheets or nets that could act similarly. In this way, blinds, shutters, doors, or other barriers can be re-enforced in order to strengthen them against larger, slower moving objects, in addition to anti-ballistic protection.

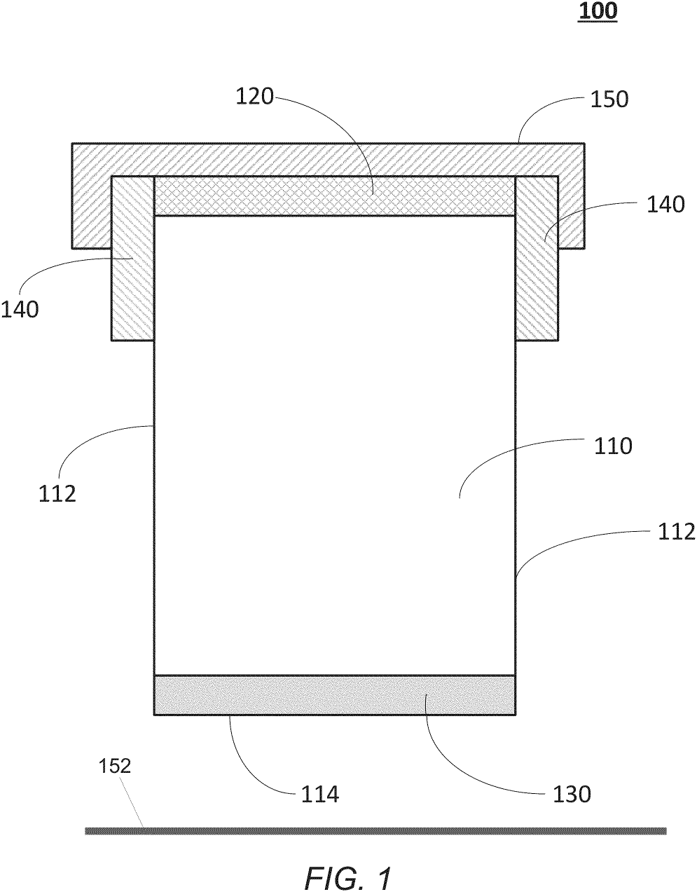

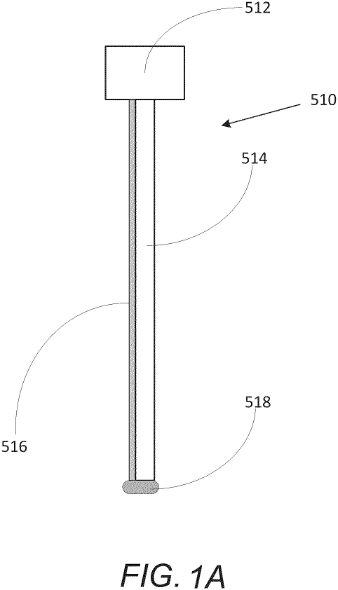

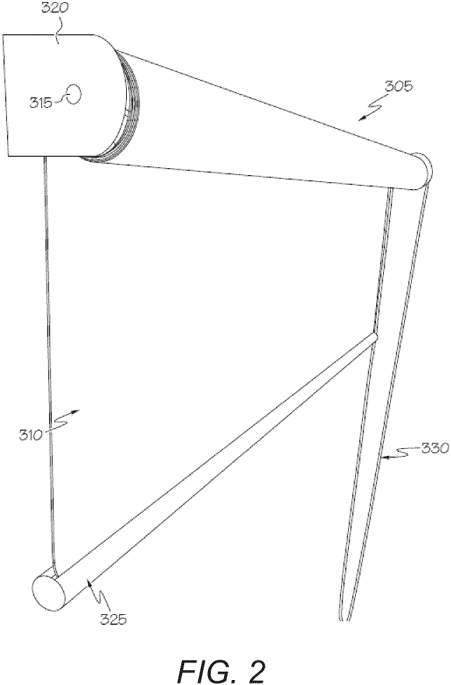

FIG. 1 shows a schematic of a basic general barrier design 100 that can be used for many of these various barriers. The primary protective part is a barrier layer 110 which in many of the example embodiments will be comprised of a laminate of a plurality of layers of flexible antiballistic material. FIG. 2 shows an example of such a laminate 400 that can be used, with an inner layer 420 that is also likely to be a laminate, and with optional outer layers 410 and 430 providing protection and/or decorative layers.

The inner layer 420 can be comprised of a plurality of layers of anti-ballistic material that might include layers including one or more of: plastic, composites, wood, metal, fabric, fiberglass or any other suitable anti-ballistic material including, but not limited to, Kevlar^{®} (which is a synthetic fiber of high tensile strength comprised of poly-para-phenylene terephthalamide) or Lexan^{®} (which is a transparent polycarbonate of high impact strength) or Lucite^{®} (which is a solid transparent plastic comprised of polymethyl methacrylate) or DuPont™ Tensylon^{®} (which is an ultrahigh molecular weight polyethylene anti-ballistic material), or a boron treated cloth, or a plexiglass with anti-ballistic properties, for example, or any combination thereof. Any type of Ultra High Molecular Weight Polyethylene could be used. Anti-ballistic gel materials such as shear thickening fluids that may be transparent can be used to saturate a material or fill voids (some of these materials harden upon impact and might be comprised of non-Newtonian fluids that that thicken in response to force). Other materials or combinations described elsewhere in this document can also be used as an alternative or supplement these materials.

Where being pared with a separate base structure (see below), one or more of the outer layers 410, 430 may be omitted, or used for structural and/or decorative purposes, as discussed. Such barriers, and in particular the anti-ballistic laminate, can have a variety of purposes. For example, these barriers are designed to:

For example, these barriers are designed to:
-Slow down bullets;
Stop speeding cars;
-Stop explosive Blast;
-Stop Fire, Firewall;
Stop a rocket, missile, or other launched or thrown object;
-Prevent Eavesdropping (possibly by vibration);
-Block light;
-Provide sound;
-Noise cancelling, Active noise cancellation; and
-Surface lights could change colors, or strobe to disorient;
Also, the barriers can be comprised of various materials:
-Fabric, i.e. kevlar, dynema, coated fibers, gels to fill layers for strength, can be used to keep barriers in place etc.;
-Ceramic/veneer;
-Gel to dissipate heat or stop bullet;
-Any hollow cavity can be filled with foam for strength;
-Various placements of hinges for support and movement;
-Modular Sections, acoustic panels, electrostatic speakers, flat speakers; and
-Shutter with metal, wood, veneer to make attractive and act as strike face (slat can also have thin metal edge for looks);

The barriers can also be provided of various sizes and configurations, such as vertical or horizontal; movable on their axis and turn/spin to displace energy efficiently; and panel sizes can vary on application, e.g., specifically for rolling panels.

The barriers can be placed in various locations, including: doorways; windows; hallways, vehicles; personal residences; schools/large buildings in need of security; garage doorways; alleyways; loading docks; shipping containers, and any location that needs protection against ballistic projectiles or blast shrapnel along with vehicle or personnel barriers.

All of the layers provided in the laminate 400 (that may be used as the barrier layer 100 of FIG. 1 516 of FIG. 1A, or the layer 310 of FIG. 2, among others provided hereinbelow) can be secured together using any combination of a number of securing approaches, including the use of glue, heat bonding, stitching, quilting, spot welding, connectors (rivets, Velcro, etc.) or other means, or any combination thereof, to secure the various layers of the laminate together. Hence, the laminate can be manufactured using stitch bonder or quilting machines, leading to a multi-layered laminate having a plurality of flexible layers and leading to a flexible laminate. Note that each layer might be comprised of thin, solid sheets of any of anti-ballistic material or the material could be woven, compressed, or otherwise provided into a durable and tough and flexible fabric using threads and/or fibers of the material. Alternatively, thin sheets of solid material could be used in place of the fabrics.

An aspect of the first surface that the bullet hits can be designed to act like a strike face, to slowdown and deform/mushroom the bullet before it hits the inside layers which then stop the projectile. For example, the outside layer can be anodized, coated, plated or treated/coated to provide the first task of slowing and deforming the bullet before it hits the layers that do the heavy lifting.

The outside strike face can have ridges or protrusions to roll the bullet. There could also be a ceramic veneer or layer to act as the strike face. The strike face layer can also be a combination of different technologies such as coating a ceramic veneer, such as to keep the weight down.

The whole barrier assembly can be spring loaded or partial break away to dissipate energy, or to move in an X, Y or Z direction. The strike faces could slide in pockets of the barrier. The hinges can be metal or composite based.

A security film can be applied to the strike face to slow down and mushroom the projectile such as a bullet. The material would not be flammable like glass and other methods currently used, would be safer for schools etc. On lightweight metal barriers or blinds (having metal slats) a coating or layer/foam, or lightweight material slides in to the extrusion or stamping.

The barrier shape can be used to change the roll of the bullet, various angles to get bullet on its side, for example. The point of the first, outer layer (other than surface decorative layer(s)) is to act as a strike face and slow down and mushroom flatten out the bullet/projectile. When glass is in front of the barrier, a security film can be applied to a surface of the glass that acts as a strike face to slow down the bullet.

On light weight metal barriers (e.g., shutters or blinds that might use slats) a coating or layer of lightweight material such as Tensylon that fastens or slides into the extrusion or stamping. The barriers could also be a clear lexan that darkens with sunlight. The barriers or shutters could also be a laminated/sage glass that darkens automatically or when electricity is applied.

Barriers can also be a shutter made of tensylon that has a metal, ceramic or wood veneer surface, to make that barriers more presentable but also act as a strike face. The slats or edges can also have a metal edge to improve the appearance. Lightweight materials light dyneema can act as a ladder or to keep the barriers aligned. A metal shutter can be a extrusion or stamping that the cavity is filled with a combination of materials foam, coating, kevlar polyurethane, or anti-ballistic gel, depending on the function of providing strength, sound dampening, strike face, decorative, etc. The fabric laminate may also be coated with various substances to help provide decorative features, or to stiffen outer layers to deform bullets, or to provide sound deadening, or otherwise provide other desirable features.

The barrier layers can be provided in modular sections that can deploy horizontally or vertically. The device can deploy from the top bottom or side. Sections can be provided in fabric or hinged, daisy chained, or wired together. Speakers and/or lights can be provided in various sizes.

The sections can be electrostatic or the equivalent of a thin speaker to block light sound bullet etc. (as described in more detail below). The barriers can provide light or emitted sound. Barriers, such as blinds or shutters can use speakers for security, and can block light and provide sound. Speakers can be provided to vibrate the barriers do active noise cancellation.

Barriers can be designed in a way to dissipate the energy from the shot through motion, destruction, heat dissipation, deformation, or other processes. They may sacrifice themselves much like a formula one car sacrifices itself to save the driver.

A cavity or pockets of the barriers (e.g., blinds or shutters) can be provided to house different modules according to the needs desired or a combination of elements. Slats could rotate on there axis to displace energy or change side according to purpose.

The barriers can be comprised of various layers of fabric material. The material layers may be secured to each other by stitching, quilting, gluing, welding, or merely the edges may be bound and perhaps tacked in a few spots leaving inner layers unsecured to each other, allowing motion or pockets for other uses, such as inserting materials or gels. Perhaps not stitch bonding or perhaps a very open quilt pattern.

A logo can be provided, such as using 1 inch or ¾ inch binding, or by sewing in a logo. As many as 18 plies or more of woven Kevlar fabric or other material can be used in the laminated material. Fabric style can be 600d Kevlar KM2 Plus, 24 × 24 square yarns per inch, plain weave construction, Polyester stitching yarn, 75 denier textured yarn. Stitch pattern can be: linear chain stitch (machine direction), 3.5 gage spacing. Quilting can be used to secure the layers to each other. Layers secured only at the ends can also be utilized. It is noted that the very looseness, flexibility, and motion of the material aids in energy absorption, providing better ballistic protection and penetration avoidance. Level IIIA or better anti-ballistic protection can be achieved.

Referring back to FIG. 1, the barrier layer 110 will be fixed at one or more ends using either or both top mounting structure 120 and side mounting structures 140 to securely connect to the structure 150 of the building or other protected space. These structures will securely fix one end of the barrier layer 110 to a secure structure, such as a window or door frame, a ceiling, or vehicle panel or frame. The barrier 110 may be associated with a retractable door. Note that where the barrier is of a deployable embodiment, the top mounting structure 120 may include features that retract and/or store the barrier layer 110, such as disclosed in a number of the parent applications in embodiments such as deployable window blinds.

In this generic approach, as discussed above, the barrier layer 110 will be a flexible layer that can move, vibrate, swing, and otherwise convert the kinetic energy of the ballistic projectile into kinetic and/or heat energy in the barrier 100 by nature of having barrier sides 112 and a barrier bottom 114 that are not secured to any structure in this free hanging embodiment. A weighted end 130 can be provided on the barrier layer 110 to add mass to the barrier so that the kinetic energy of the projective is also transferred to this mass as kinetic energy by moving the mass of the end 130, which can include lifting the end, swinging the end, and other types of motion. The end 130 also helps keep the barrier 100 in place by providing stability and in a deployable embodiment, may also help deploy the barrier 100 in emergency situations, as is also discussed in the parent applications.

Note that automatic deployment, based on the detection of a dangerous situation such as an explosion or gunshot (e.g., triggered by sound waves, breaking glass, light flash, or even detection of intruders, for example) can be provided as discussed in the parent applications. Manual deployment through activation of a motor or drop function through use of a switch, lever, or other manual activator can also be provided as an alternative or supplemental means of deployment. The weight 130, when provided, can aid in quick deployment and stability. Such barriers can be provided in windows, doorways, hallways, or even across rooms, for example.

Alternative approaches where the barrier is installed in a rising manner could also be provided. For example, posts may rise out of the ground or floor for deploying the barrier from the ground up, with the top portions free to move, or with sufficient flex in the barrier to allow freedom of motion. Such devices can protect hallways, stages, rooms, doorways, garage doors, or other locations in and out of buildings.

As an alternative, the side mounting structures 140 may be extended further, even along the entire length of the barrier sides 112, to secure the sides. Such structures may be mechanical rails or magnets that secure the deployed barrier on its sides. Grooves in a door frame or other structures could be used to secure the sides. Alternatively, linking edge structures can be provided that interlink when extended to add stiffness and structure to the sides of the barrier.

Furthermore, an optional floor structure 152 can be provided at a bottom of the barrier 100, such as on or beneath a floor, to secure the barrier bottom 114 when deployed. For example, bottom 114 may include a magnet along it’s length as part of the weight 130, and the floor structure 152 could include a magnet of an opposite pole (which may be an electromagnet), to secure the bottom 114 to the floor. Alternatively, floor structure 152 might include a latch or gripping device that secures the bottom 114 to the floor. Hence, in conjunction, extended side mounting structures 140 and/or the floor structure 152 secures the barrier 100, when deployed, to prevent individuals or objects from passing beyond the barrier 100 into a protected region.

The embodiment of FIG. 1A could be similarly configured utilizing any of the options described above, among others. FIG. 2 shows a particular embodiment of the generic approach of FIG. 1 by providing a barrier 305 with support and stowing structures 320, 315 for deploying the barrier layer 310 with weight 325 in a window or door frame.

Note that automatic deployment, based on the detection of a dangerous situation such as an explosion or gunshot (e.g., triggered by sound waves, breaking glass, light flash, or even detection of intruders, for example), or a shouted command, or speeding vehicle can be provided. Manual deployment through activation of a motor or drop function through use of a switch, lever, or other manual activator can also be provided as an alternative or supplemental means of deployment. The weight 130, 518, 325 when provided, can aid in quick deployment. Such barriers can be provided in windows, doorways, hallways, or even across rooms, for example. Such barriers can be provided with retractable doors to add anti-ballistic features to current or new doors.

Alternative approaches where the barrier is installed in a rising manner could also be provided. For example, posts may rise out of the ground or floor for deploying the barrier from the ground up, with the top portions free to move, or with sufficient flex in the barrier to allow freedom of motion. Such devices can protect hallways, stages, rooms, doorways, garage doors, or other locations in and out of buildings.

Note that barriers that are constructed of ceramic or composite ballistic material can be much lighter and cheaper to build than barriers that use metallic materials, such as steel, for example, and they could prove flexible and more deployable and retractable.

Barriers using fabric and/or panels held together by fabric can be utilized. Also having barriers in a horizontal or vertical position. Closing and opening from all possible sides can be provided, e.g., from the top or bottom or left or right. Also, a combination of these approaches can be used. Barriers could close from both sides. Or close from the top and bottom where each barriers half covers half of a particular window.

Roll down fabric barriers using ballistic materials that come down from the top, such as that can be quickly deployed can prove useful. Also panels that fold down from the top can be utilized.

Ballistic resistant panels can be provided with the ballistic material provided on back of an ornamental design (e.g., wooden slats), or between ornamental designs, so that the barriers provide traditional ornamental aesthetics. The ballistic materials may be woven into a layered cloth that can be attached, glued, or otherwise combined with the ornamental panels to achieve the desired effect. A string or rope made of the ballistic material can be used to replace the string/rope that may be utilized in existing applications. Various barriers comprised of laminated structures of various shapes, sizes, and configurations are described hereinbelow.

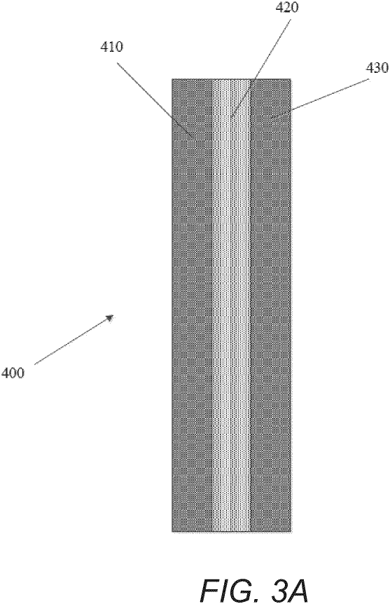

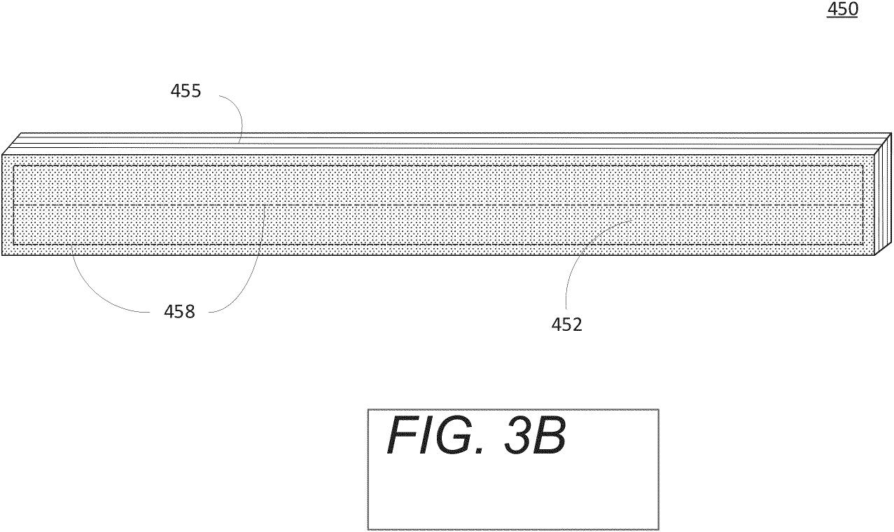

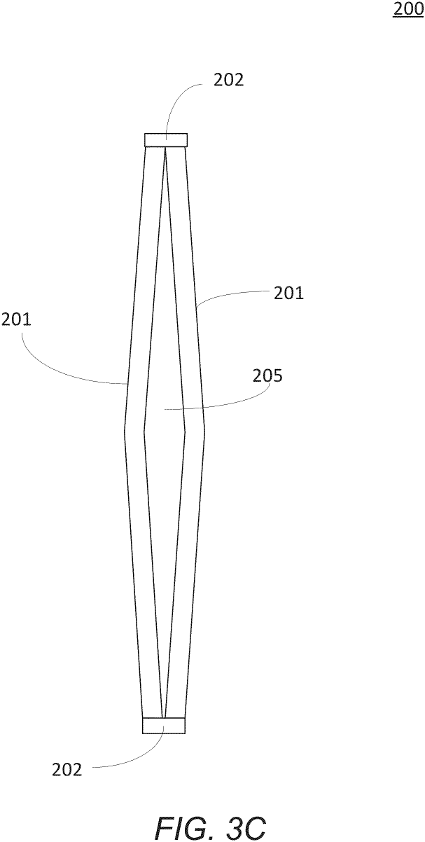

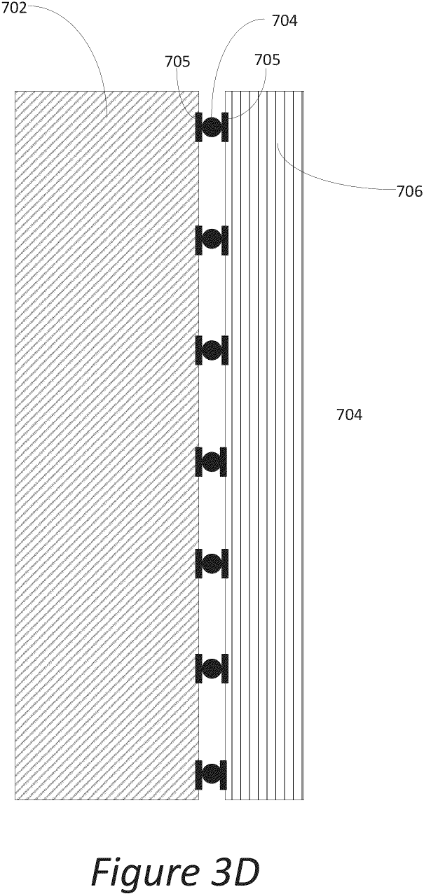

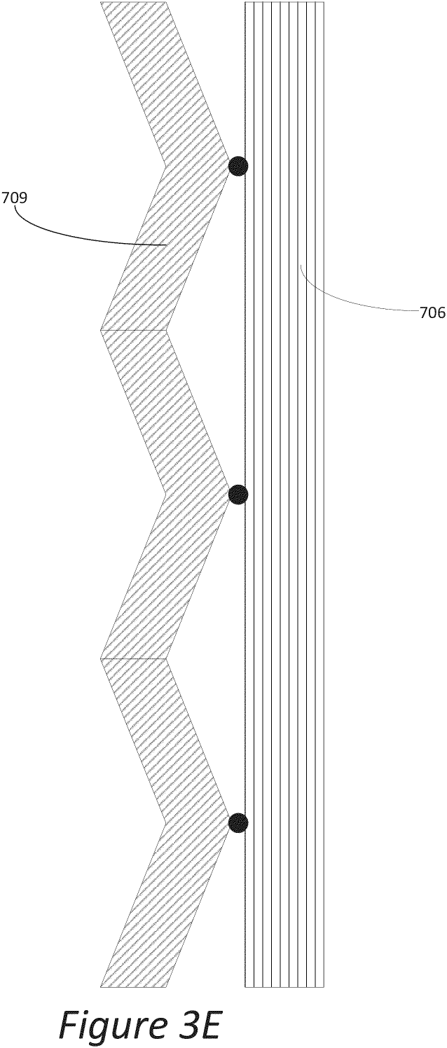

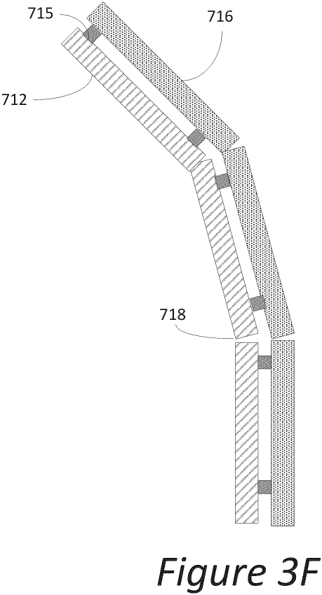

For example, FIG. 3A shows a side view of a laminated slat 400 having ballistic layer 420 that can be used as a system using an anti-ballistic barrier (laminated structure), being sandwiched between optional decorative or structural layers 410 and 430 providing protection, structure, and/or decorative layers. As an example, layers 410, 430 could be a single layer of fabric surrounding a ballistic panel as layer 420. Or ballistic layer 420 might comprise a ballistic fabric, making the entire slat of layers of fabric and/or sheets of material. Hence, part of the barrier, such as louvers/slats, can be made in this laminated manner to provide both decorative and anti-ballistic features. The layers could be glued together, or bonded in some other manner, such as by heating them to weld them together or stitching them together using a strong thread, as described hereinbelow. A lamination machine that binds the layers using heat can be used.

FIG. 3B shows an example barrier comprised of an anti-ballistic laminate structure 450 having a plurality of layers of flexible, anti-ballistic material 455 and a decorative (or structural) top layer 452 that are stitched together using stitching 458 which can act as a barrier. An embodiment may use any number of layers of anti-ballistic material, which may be a woven cloth material or a thin sheet. For example, such a barrier might use two, or more than two such layers. In a preferred embodiment, 18 layers of level IIIA bullet proof material, such as an antiballistic cloth material or thin sheets of material as discussed above can be stacked into a laminate that can be glued, heat welded, or stitched using a thread, such as nylon, polyester, Kevlar or Dyneema® threads, to secure the layers together. The top (and in some cases bottom as well) decorative layer 452 can be comprised of a decorative cloth or sheet. A binding material or strip can be put around the outer edge of the sheets or slats for decorative purposes or for physical support and further binding to form the resulting laminate structure. For large sheets of materials, stitching will be provided at periodic intervals (e.g., 0.75 inch spacing).

For example, 18 plies of woven Kevlar fabric such as a 600d Kevlar KM2 Plus, 24×24 square yarns per inch, plain weave construction, polyester stitching yarn, 75 denier textured yarn with a stitch pattern from a linear chain stitch (machine direction), 3.5 gage spacing or 0.75 inch spacing.

Sheets of material of the barriers having any desired width and length, or configured, or individual slats, may have the individual fabric sheets bound by using a glue or substance around a perimeter of the sheets or a pair of edges to hold the sheets together, but let the layers remain unbound in an interior portion. FIG. 3C shows a side view of an example two-layer laminate structure 200 with first and second fabric layer 201 having only upper and lower edges 202 bound with an edging material (such as stitching, bonding, edging, etc.) leaving an inner gap 205 formed from the loose material. Of course, any number of layers can be used in the laminate rather than just 2. This approach could be designed to self-destruct in order to better absorb the energy of a projectile.

Alternatively, tensylon slats can be used for barriers, such as venetian style blinds. As an alternative, a thin layer of steel as a strike face can be provided on the slats to improve the anti-ballistic properties. Tensylon slats, with or without the steel surface layer, can slide in pockets on the kevlar fabric blinds to add further protection, such as in solid sheets that are rolled up when retracted and unrolled when deployed, as described hereinabove. Such barriers re flexible and lightweight, and could be designed to level 4 protection to stop rifle rounds.

FIG. 3D shows an example of a laminated structure 706 attached to or mounted on base structure 702 which might be a retractable door or other type of structure such as storm shutters or walls. A plurality of attachment structures 704, 705 are used to attach the laminated structure 706, which has anti-ballistic properties, to the base structure 702 where it is desired to improve anti-ballistic properties. The attachment structures 704, 705 might be comprised of magnets, snaps, rivets, screws, welds, or other structures to hold the laminated structure 706 to the base structure 702 so that the laminated structure deploys and retracts with the base structure, such as on a garage door, window shutters, etc.

It may be desirable that the laminated structure 706 be loosely connected to the base structure 702 to allow for flexing and oscillating for better energy absorption. (e.g., see FIG. 3C. Furthermore, the attachment structures 704,705 may be designed to be releasable, in that they release the laminated structure 706 from the base structure 702 to better absorb energy from a ballistic object through enhanced motion and/or oscillation.

For example, the attachment structures 704,705 may be comprised of a base 705 that may include magnetic material, such as steel, iron, nickel, etc., and a magnet 704. The attachment structures 704,705 will use magnetic attraction to attach the structures 702, 706 together in normal circumstances, such as static situations and retraction and deployment, but my release the laminated structure 706 from the base structure 702 in cases of antiballistic protection. For such an approach, the magnets 704 may be spheres, or cylinders, with the base 705 matching the length/width of the magnets 704.

Similarly, the attachment structures 704,705 may be comprised of hook and loop fasteners, or a severable structure such as relatively weak fasteners, releasable snaps, weak glue or weld bonds, breakable threads, or other releasable structures.

Alternatively, the attachment structures 704,705 may be permanently affixed to avoid separation of the layers, such as by using rivets, strong glue or welds, screws, or other types of permanent fastening.

FIG. 3E shows a solution with a type of corrugated base 709 attached to the laminated structure 706 using any of the various connectors discussed herein. Doors using such a base corrugated 709 are thin, and easily roll up to retrace. Using a thin, flexible laminated structure loosely connected to the base allows the final device to continue to be rolled to retract the door. To improve on the flexibility, the laminated structure could be nested within the curves of the corrugated base, such as by using a weak glue, allowing it to bulge out during an ballistic event for more energy absorption.

The laminated material of FIGS. 3A or 3B or 3C or 3D can be formed into slats or have foldable creases or be sufficiently flexible to form venetian blind or shutter style barriers, deployable/retractable doors or storm shutters, or alternatively into sheets to form solid barriers that can be used in homes or vehicles as discussed herein.

For Example, FIG. 3F shows a retractable door design having a plurality of base structure slats 712 attached to a respective plurality of laminated structure slats 716 using fasteners 715. The breaks 718 between the individual slats allow the structures to wrap, or roll, up upon retraction. Alternatively, the structures could be made sufficiently flexible to roll up without any need for breaks, or where the breaks are just slits in the structures to allow for more flexibility.

The above solutions are particularly useful in re-enforcing existing doors, shutters, walls, or other structures (e.g., by retrofit) to improve their anti-ballistic properties. For example, using some version of the solution of FIG. 3D, the anti-ballistic laminated structure can be attached to an existing door (or shutter or wall, etc.) or existing door (or shutter or wall, etc.) design by placing the laminated structure on an exterior surface of the door, using one of the methods of attachment described above. By having the layer somewhat loosely attached, or detachable from the door, the energy of the ballistic device can be better absorbed.

Alternatively, if a primary goal of a door is to improve its protection against larger objects like people or vehicles from entering the space, more permanent attachment is desired, possibly also with attachment of the laminated structure to a wall, floor, or ceiling, or all of them, to act as a protective “net” to stop entry by such objects. Or the laminated structure can attach to strong structural components of the door itself, such as outer frames, or structures that connect the door to side walls, for example.

This solution can be utilized on any type of door or shutter, whether retractable, roll up, swinging or sliding, for example, which may be constructed of metal, plastic, cloth, wood, laminates, composites, or other materials or combinations thereof.

As a further alternative, combinations of these features could be utilized. For example, outer portions of the laminated structure can be permanently attached to the outer frames of the doors and on an outer surface of the doors, but leaving slack in the laminated structure with looser or detachable attachment in center portions of the door or shutter, such that there is detachment and flex in center portions of the laminated structure during a ballistic event, but the laminated structure stays permanently attached to the door or shutter.

The laminated structure might have adjustable tensioning, such as by using a spring, bungie, rubber, or other component, such as around an edge. This would keep the laminate taught, but allow some vibration, oscillation, and flexing to absorb energy. The tensioning might be manually adjustable by using an adjustment on the device to adjust the tension. As a further alternative, any of the above laminated structures might be configured to only be associated with a part of the base structure. For example, in some cases doors may be provided that have a relatively high height, such as in warehouses with high ceilings, etc. In such a case, if the primary objective is to protect occupants on the ground from ballistic threats, it may be beneficial and cost effective to only provide laminated structures for a lower portion of, for example, a retractable door. For example, maybe the lower 8 or 9 or 10 or 12 feet (or any desirable length) of the door, for example, need be provided with a laminate structure attached thereto. This will require less length of the laminated structure, but still protect the occupants.

Alternatively, only certain sections of a door might be protected, but not all, such as in a building where they might also be occupants at a higher level, such as on a catwalk or upper floor portion. Any portion of the door could be outfitted with ballistic protection by providing one or more portions of laminated structures in locations that protect occupants or property inside of the door.

Furthermore, by producing the laminated structure with fire resistant materials, this approach can provide fire and heat protection as well. Hence, the solution can provide bullet, fire, and blast protection, along with some additional protection against entry by vehicles and/or personnel, etc.

Because the laminated structure can be installed on an outer surface of the base, it can be applied after manufacture of the door, or even after the door has been installed into a building (i.e., retrofit).

Of course, either the base structure, or the laminated structure, or both could be provided of any desired length and/or width in order to protect an entrance, doorway, hallway, etc. of any size. Alternatives where the base structure is designed to rise from the floor, and hence pull up the attached laminated structure, can also be provided, such as to protect interior portions of a room, such as a stage or podium or other part of an interior structure.

Alternatively, such protection from structures rising from the ground could be provided outdoors, such as by providing a rising set of walls to form an interior space portion to protect. Other locations outdoors could utilize drop down versions, such as pavilions, patios, porches, or other locations where people might gather.

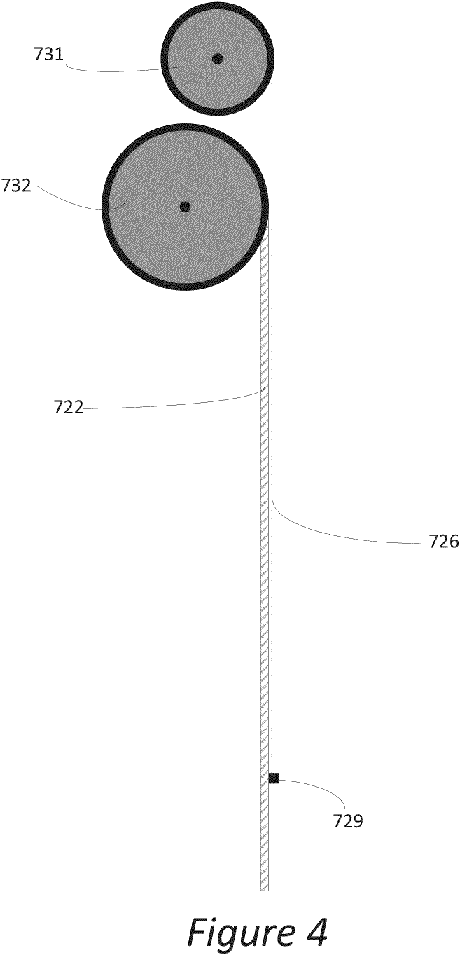

FIG. 4 shows an alternative arrangement where the anti-ballistic laminated structure 726 is deployed using a separate deployment structure 731 versus the base structure 722 using another deployment structure 732. In this example, each structure 722, 726 can be separately deployed and retracted. A weight or magnet 729 might be provided at the bottom of the laminated structure 726 to aid in deployment.

The arrangement of FIG. 4 would allow the two structures 722, 726 to be independently deployed for increasing the flexibility of operation. For example, if base structure 722 is a deployable door, the door might be retraced to allow a person or vehicle to enter, but keeping the laminated structure 726 fully or partially deployed to continue protection. For example, person might just push aside a portion of the structure 726 to enter, whereas a door would prevent entrance of the person.

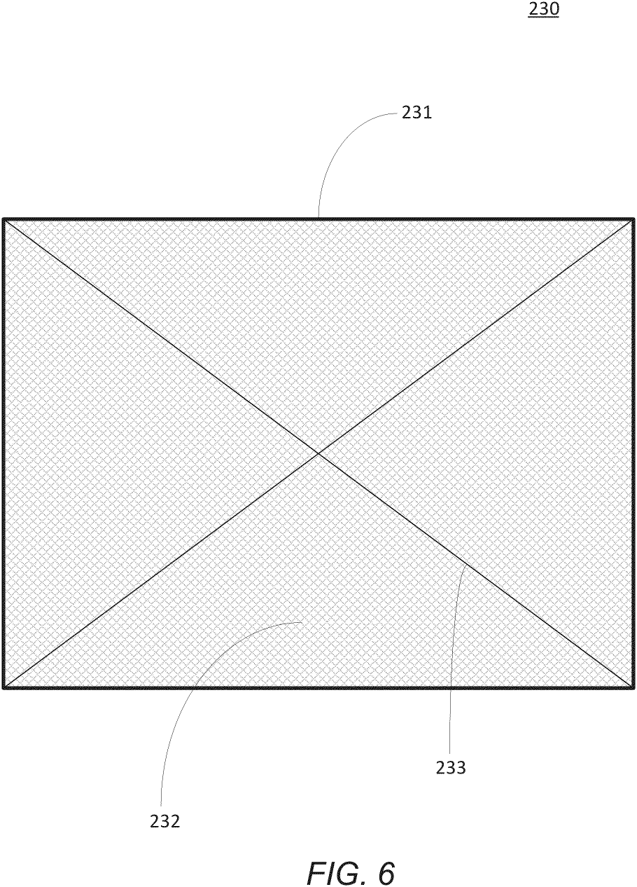

Of course, a single deployment structure can be utilized when the laminated structure 726 and the base structure 722 are integrated together. Or a structure similar to that shown in FIG. 2A could be utilized to form a door utilizing outer base structures for layers 410, 430 with an inner layer of laminated anti-ballistic structure. Additional layers could be provided for decorative or additional strength or anti-ballistic features. Such doors can be reinforced as described herein for FIG. 6.

The arrangement of FIG. 4 might still provide for the laminated structure 722 being attached to the base structure through the use of magnets, electromagnets, side rails (such as a rail being attached to the base structure for the edges of the laminated structure sliding in the rail), or other structures to restrain the laminated structure from being pushed or pulled away from the base structure. Alternatively, the laminated structure may freely hang, or be fixed at a base once deployed, such as by using a locking structure, magnets, electromagnets, etc.

The various barriers disclosed herein could be utilized in a configuration similar to that of security shutters, in at least a portion of the shutters could utilized fabric materials to better absorb energy from the projectiles such as bullets. A metallic face of the shutters could be used as a strike face to deform a bullet and then a layer of fabric material in a sheet or slats could be used to fully stop the bullet or shrapnel. Or hollow portions within various slats of the shutter could be filled with the barrier material provided in strips, for example, or filled with an anti-ballistic gel.

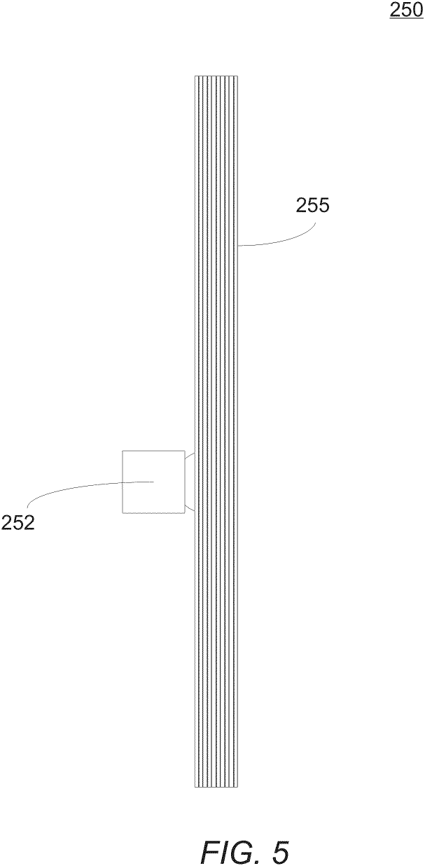

FIG. 5 shows an example laminated barrier 250 with laminate 255 having a speaker (or vibrator) 252 attached to vibrate the barrier in order to provide security by preventing monitoring of the barrier (and hence the room) using a device such as a laser vibration monitor. Alternatively, the speaker might be provided at another location, such as in mounting structures. By vibrating the barrier using the speaker, the barrier essentially creates noise that make surveillance of the room more difficult. If an outer stiff layer is used on the laminate, the speaker may be attached to that layer. This approach can also be designed to provide active noise cancellation in that the speaker, rather than just creating noise, is attached to a sound detection system to actively cancel room sounds in the manner done in active sound cancellation systems.

Alternatively, other devices that are actively “listening” to ambient noises or “watching” for activities could be used as sensors to monitor for sounds that indicate a location is under attack for communication to a control system. Sounds such as explosions or gunshots, smoke (and other gunfire or explosive products), breaking glass, explosions, or voice command (e.g., “deploy barrier” or “deploy blinds”), to deploy the barrier or blinds. For example, the Amazon Echo device (or the similar Echo Dot, Echo Show, Echo Plus, Echo Spot, Echo Auto, Fire Devices, among other devices), using the Alexa application (or a related application, such as the Amazon Alexa Guard app), can actively listen to ambient room noise, and could be utilized to monitor for such emergency sounds and then respond by actively deploying the barriers, using Alexa’s automation applications. These devices have Bluetooth connectivity, and connect to such other monitoring devices as video cameras (e.g., Blink), and video doorbells (Ring), etc., which permit active networking of devices to respond in concert to any detected threat by audio, or, when using video devices, by video (such as detecting a person holding a gun or other weapon, etc.). These are described in more detail hereinbelow.

FIG. 6 shows an embodiment of a barrier device 230 having a strong frame 231 around a perimeter that might be made of a metal or non-metallic materials, such as an antiballistic material as disclosed herein. The frame 231 might be solid, or comprised of a chain or rope or twine including anti-ballistic materials as disclosed herein. This frame 230 can be made of woven lightweight anti-ballistic materials as discussed herein, or metallic materials could be used. Such a frame should be strongly attached to a frame or walls or a floor or other part of the building or a strong deploying structure in order to stop large, moving objects such as vehicles or large pieces of shrapnel, thrown objects, objects fired using a mortar or other launching device (e.g., tear gas canisters), etc. A door can be reinforced using such an approach.

A netting or mesh woven material 232 can be used that is comprised of the strong, light-weight anti-ballistic material disclosed herein, either formed into solid strands or woven as a rope or twine material to form a mesh having any desired gauge and gap size between strands. Solid woven materials that are flexible and lightweight can be used. Reinforcing cables or ropes or chains or bars 233 can be provided entwined or attached to the material 232 to strengthen the overall barrier 230. These reinforcing structures 233 can be made of woven lightweight anti-ballistic materials as discussed herein, or metallic materials could be used.

Such a barrier can be used in a doorway, hallway, or building vehicle or pedestrian entrance, for example, to stop vehicles, shrapnel, people, etc. from entering the interior of the building.

This barrier 230 might be installed on an interior of a door, garage door, deployable shutter system, over glass, deployable blinds, etc. The barrier 230 might be installed in an interior of such items as well. The barrier 230 might be made sufficiently transparent to be installed over or on windows in either a deployable, or permanent manner. Alternatively, the barrier 230 might be deployed in hallways, entryways, as room dividers, etc., allowing deployment during emergency situations to provide ballistic protection and barriers.

Doorways or other egress/ingress or pathway locations for vehicles or personnel can also be provided that operate in a fast open and fast close embodiment, some of which involve a shutter-like design with slats, rods, or bars that roll up the door into a spiral on a retraction roll that is motorized for quick deployment and retraction. Again a weight can be provided to provide rapid deployment and stability. Rather than, or in addition to, slats, a flexible fabric or other material, such as the anti-ballistic materials described herein, can be utilized for the door. The barrier 230, which would be made flexible to allow it to roll or fold with the door to retract and deploy, can be provided on an outer or inner surface of such a door, or it can be provided in an interior part of the door in a laminate design (such as disclosed for the related blinds, shutter, or door designs, incorporated herein) where the door is comprised of flexible materials like rubber, woven cloth, plastic or foam sheets, metal slats, etc. Such a door can quickly open and close for fast ingress and egress.

The barrier 230 could be flexible to allow retraction, such as by making the main portion 232 of flexible anti-ballistic sheets or mesh or netting, and making the frame 231 rollable, such as by using a chain, rope, cable, slats, etc. the material 232 would also be flexible to allow retraction and stowage. Or the barrier 230 could be formed into slats or foldable panels.

Fireproof materials can be provided on the door or barrier layer to add fire resistance to the door, and insulation can be added to protect an interior from heat of fire, for example. For example, a silica layer, silica sheet, silica cloth, or other surface treatment could be provided to add fire and heat resistance, as can other materials such as fiberglass, asbestos, etc. An air blower/fan can be provided to blow cooler air from the floor or another source upward over the door to keep it cool in case of a fire situation.

Such a door can be modified to protect against ballistic objects as well, as discussed regarding the disclosed designs, also incorporated herein. Hence, such barriers can be provided in hallways to wall-off portions of interior buildings or protect those interiors from external access, providing barriers against intruders whether on a vehicle or not, and to protect against ballistic projectiles such as bullets or shrapnel from explosions. By providing fire resistance, the barriers can also protect against the spread of fire and its resulting heat. The barriers can also protect against explosions and ballistic projectiles like bullets, shrapnel, etc.

As discussed for blind designs above and in the referenced applications, such barriers might automatically deploy upon detection of heat, an explosion, gunfire, or another alarm condition that might be automatically detected or manually activated. Emergency responders also might deploy the systems, as might burglar alarms, fire protection systems, etc.

Such a door barrier can be made sufficiently strong to stop a speeding vehicle. If the door is designed to flex and stretch, it can absorb much of the kinetic energy of moving objects without breaking, protecting an interior space and avoiding penetration by the undesirable object.

Furthermore, existing doors can be outfitted (retrofitted) with an added layer of material as disclosed hereinabove, such as by providing the ropes and/or layers of netting or other forms of the lightweight anti-ballistic material to add additional structure and energy absorption capability to an existing door. In such a situation, the retrofit barrier might be attached to the door using a glue, welding, mechanical fastener, Velcro, or other means of fastening the barrier to an existing door. Such a retrofit would allow the door to continue to be retracted or opened in the original manner.

In particular, a deployable barrier system using any of the above approaches is desired that can stop objects of substantial mass from penetrating the barrier and entering the protected space. Objects of substantial mass on the order of pounds, tens of pounds, hundreds of pounds, and thousands of pounds are contemplated to be protected against. For example, protecting against thrown objects like large rocks, bricks, liquid or solid filled bottles, rockets, missiles, mortar rounds, drones (such as drone vehicles), personnel vehicles of any size or weight, running individuals, battering rams, etc. Barriers that protect against one or more of these types of objects using strong, lightweight anti-ballistic materials is desired.

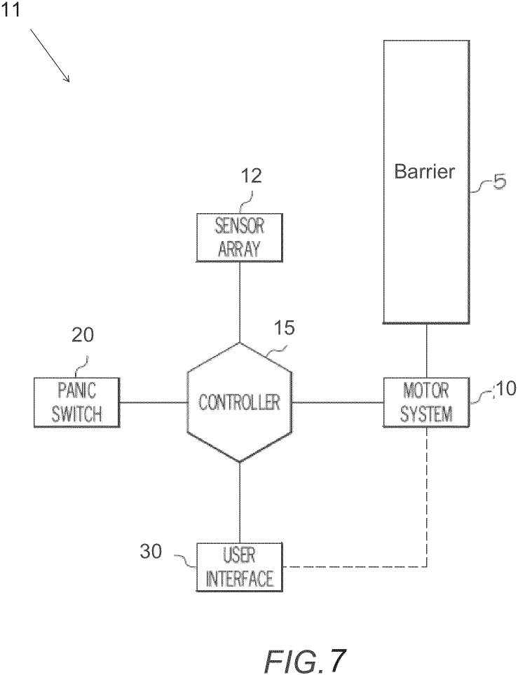

FIG. 7. Illustrates an example of a control system 11 which may be used by any of the embodiments described herein to control the barrier system 5. The control system can include a controller 15 with one or more sensors that form a sensor array 12 connected to the controller 15, and a panic switch 20 connected to the controller 15. The sensors may be pre-existing sensors in a home defense system or conventional after-market sensors capable of detecting ballistic signals such as sound (e.g., gun shots or breaking glass), gun powder, gun impact, muzzle flash, temperature, and the like. The sensors could be any of those typically used to detect a break in, for example. The controller 15 is connected to a user interface 30 whereby a user may activate and apply settings to the barrier system. The controller 15 is also connected to a motor system 10 for actuating the barrier system upon receiving information indicating that a threat is present and that the barrier should be deployed (i.e., put into a protective state such as a ballistic protection mode).

Where a building may already have a central control system (e.g., a security or other alarm system with computer control), controller 15 may utilize such a system by adding additional customized code for operating the barrier system 5. In another example, the barrier system could also utilize ground sourced radar, infrared (heat), sonar, or some other active or passive detection system. The sensor array 12 can include one or more heat sensors, infrared sensors, video sensors, audio sensors, smoke detectors, or other types of sensors, or may utilize already existing sensors of a fire or burglar system, for example. Any of the sensors in the sensor array 12, the panic switch 20 or the user interface 30, or any combination of these components, may be connected to the controller 15 in a wireless manner, such as by Wi-Fi or Bluetooth, for example, and the panic switch and/or user interface could be implemented on a cell phone or tablet computer, for example.

Alternatively, the control system 11 might be part of a smart system such as smart speakers or a burglar alarm system using such devices.

The system or any of its components may be controlled by any external or internal system, such as one that may exist prior to the installation of the barrier(s). For example, the barrier system could be tied to an external system such as an alarm system or video cameras with analytics. The barrier system could also be controlled remotely via the internet or a Wi-Fi or Bluetooth^{®} connection by any connected device such as a tablet, computer, PDA, or a smartphone. Barriers such as disclosed herein would be very useful in a panic situation in a school or federal building. Such barriers could also be used in a lock down situation to prevent people or valuables from leaving the premises, for example.

The control system 11 of FIG. 7 can be networked with other smart systems that are used in a home, business, or other location. For example, other devices that are actively “listening” to ambient noises or “watching” for activities could be used as sensors to monitor for sounds that indicate a location is under attack for communication to a control system. Sounds such as explosions or gunshots, smoke (and other gunfire or explosive products), breaking glass, explosions, or voice command (e.g., “deploy barrier” or “deploy blinds”), to deploy the barrier or blinds. For example, the Amazon^{®} Echo^{®} device (or the similar Echo^{®} Dot^{®}, Echo Show^{®}, Echo Plus^{®}, Echo Spot^{®}, Echo Auto^{®}, fire devices, among other devices), using the Alexa^{®} application (or a related application, such as the Amazon^{®} Alexa Guard^{®} app), can actively listen to ambient room noise, and could be utilized to monitor for such emergency sounds and then respond by actively deploying the barriers, using Alexa’s automation applications.

Similar devices marketed by Apple^{®}, Google^{®}, Sonos^{®}, and other vendors could be substituted for the Amazon^{®} devices. These devices have Wi-Fi and Bluetooth^{®} connectivity, and connect to such other monitoring devices as video cameras (e.g., Blink^{®}), and video doorbells (Ring^{®}), etc., which permit active networking of devices to respond in concert to any detected threat by audio, or, when using video devices, by video (such as detecting a person holding a gun or other weapon, etc.).

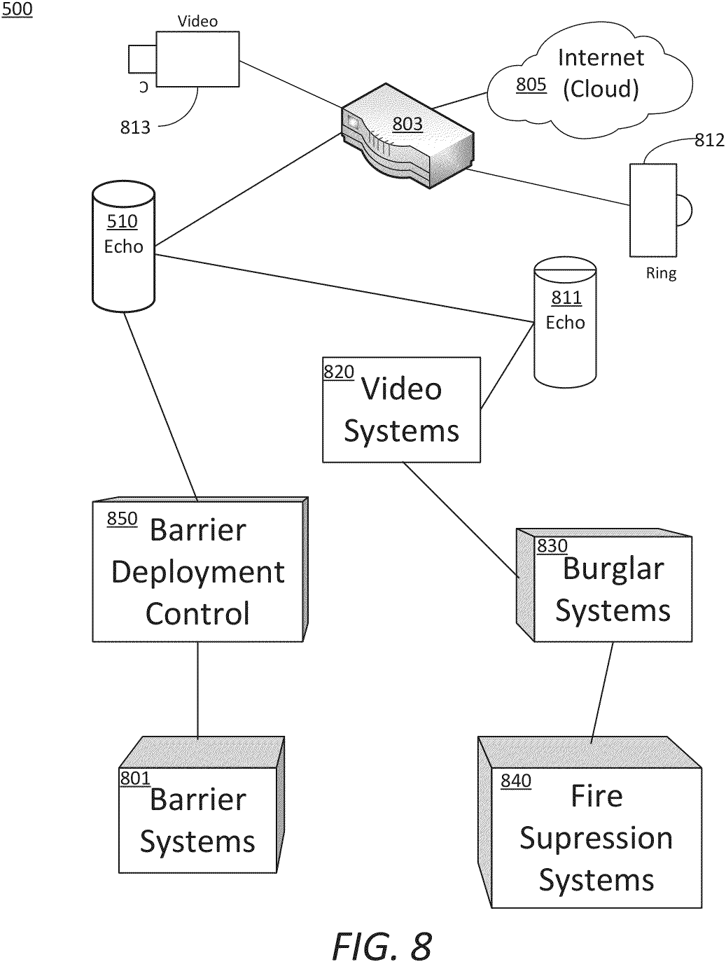

FIG. 8 provides an example integrated system 800 that can be provided for automating a barrier deployment system. In this case, a router 803 (such as a wireless or wired ethernet system or cable modem system) connects to the Internet 805 to access cloud services and remote servers. The router provides internal network connectivity to the other networked components. In this example, Echo^{®} devices 810, 811 are attached to the network, such as via Wi-Fi connectivity. Ring^{®} doorbell systems 812 can be used to provide external video. Video cameras 813 used with Video systems 820 can also be attached, along with any burglar systems 830, Fire suppression systems 840, and other types of systems that monitor a region using sensors, video, panic switches, etc.

A Barrier Deployment Control system 850 can be provided to control any Barrier Systems 801 with automatically deployable barriers. In this way, the various systems communicate with each other in a shared, artificial intelligence environment to share sensor information gathered by each of the systems, and to operate the systems in an integrated, coordinated manner. Hence, when a burglar system detects an intrusion, barriers might be deployed to protect entrances. Similarly, if smart speakers detect breaking glass or gunshots, a burglar system might set off an alarm, and notify security personnel.

For example, an Alexa^{®} activated device can send Smart Alerts^{®}, via phone notifications, if an Echo^{®} device detects the sound of smoke alarms, carbon monoxide alarms, commands, or glass breaking. Alexa^{®} could automatically control barrier deployment, compatible smart lights to make it look like someone is home, notify authorities, etc.. Alexa^{®} can also arm a Ring^{®} or Blink^{®} or ADT^{®} security system, call authorities, or set off alarms. This can include integration with other smart devices, such as smart locks, security systems, contact/motion sensors, etc.

Echo^{®} running Alexa^{®} and similar devices can be provided in multiple rooms and buildings and integrate with other safety systems such as security cameras and fire suppression systems. Alexa^{®} could direct children or law enforcement where to go to get away from any threat whether it’s an active shooter or a fire. Distributed smart speakers can help guide individuals to safety by directing them to safe areas or exits. In addition to audio it could give visual clues perhaps color codes for deaf people. Visual clues could be seen from a much further distance. When integrated to blue tooth and Wi-Fi it could alert and direct children on their phone to evade/escape. The system can be used to pinpoint locations of people/children and guide them through smoke or darkness, including through heavy smoke or away from an active shooter, for example.

By using Alexa^{®} devices and applications in numerous classrooms or offices one can pinpoint the location of the shooter. For example if there is a courtyard with surrounding classrooms, a shooter could be monitored and followed. Or in a residential community with multiple residences or in a city with multiple offices and buildings all the Alexa^{®} devices can share information such as gunshot glass breakage smoke heat etc. To help authorities or building systems pinpoint the location of threats to take offensive defensive measures. The system could also change colors and flash so the fire department or police could have visual alerts. These audio or visual alerts could also guide the children or office worker where to go to evade the assailants. By sharing information between multiple integrated systems, problems can be detected and actions can be taken. Lights doors ventilation etc.

Alexa^{®} can also be used in utility rooms and data centers for predictive maintenance when heat sound or light than corresponds to various problems. For example a heat exchanger fan motor could be replaced based on the change in sound or temperature. Alexa^{®} could also take weather into account to control various systems and predict outages for as simple as replacing lights.

Security components such as Ring^{®} doorbell systems, video systems, window detection sensors, heat sensors, smoke sensors, etc. can all be integrated together and used to determine the status of an enclosure (e.g., home, business, store, etc.) or another location (yard, street, park, etc.) and the proper protective devices triggered, alarms activated, and proper people and other systems notified.

Similar devices could be added or substituted for the above described devices, such as Google’s^{®} Home ^{®}devices (e.g., Home Mini, Big Home Max, Home Hub), Apple^{®} HomePod^{®}, Harman-Kardon Allure^{®} and Invoke^{®}, Lenovo Smart Display^{®}, Triby Smart Speaker^{®}, Mycroft Mark 1^{®}, JBL Link View Smart Speaker^{®}, Sonos One^{®}, among others, along with the Apple^{®} Siri^{®} app and the Windows^{®} Cortana^{®}. Any of these systems and/or applications could be adapted in a similar manner as discussed above with respect to the Alexa^{®} devices.

Such systems could also be utilized to deploy burglar defense systems such as disclosed in U.S. Pat. No. 10,229,569 filed on Mar. 14, 2014, and incorporated herein by reference, that deploy anti-burglar substances such as pepper spray or tear gas or identification inks. These systems can then be used to deter burglars and other invasion attempts.

By networking the various smart systems, including microphones to monitor sound and voices (including gunshots, breaking glass, etc.), video cameras to capture faces, movement, and break-ins, heat and smoke detectors to detect fires, cell phone detectors can be used track individuals by using Bluetooth^{®} or other cell phone features (with individuals registering their phones with the protective system), and other types of sensors, a protected space can be monitored for potential intrusion and other threats. The use of voice and face recognition can be used to register residents and guests to detect unauthorized intruders, for example. When threats are detected, various defensive measures can be deployed, such as deploying automated barriers (as discussed herein), triggering alarms, calling the proper authorities (fire or police, for example), starting recordings of video and audio activity, deploying defensive gas or liquid deterrents, etc.

The barriers could be retrofitted to an existing building or other structure, and adapted to tap into existing security or burglar alarm systems, for example, or they could be added during structure construction.

The barriers could also be adapted to sense the location of the occupants of the building and close by according to predetermined parameters such as direction of threat and the location inside the building that would be the best to return fire from. barriers could also be controlled by facial recognition, video analytics, or by the occupants’ voice or any other suitable biometrics, such as for recognizing an threatening person, such as an ex-spouse, or ex-employee who has made threats or acted in a threatening manner, or otherwise recognizing a wanted criminal or an enemy soldier, for example. When a barrier system is activated, the barrier may deploy as discussed above so as deflect bullets, shells, or other ballistic weapons to prevent a fatal impact and/or property damage. Such barriers can protect from thrown objects as well, such as rocks, grenades, bricks, Molotov cocktails, etc. Barriers could be controlled individually or together with a timing mechanism.

The barriers could be configured to protect against remote monitoring of sound and conversation, such as by providing random vibrations to the barrier to avoid vibration detection by remote monitoring devices, for example.

As an example use, the barrier system may be provided in an open state where the barriers are provided in an retracted condition to allow viewing or travel through the barriers, or the barriers in a retracted position. The barrier system sensor array would detect a potential intruder or the sound of gunfire using visual, auditory, or other sensed information. The system would then automatically enter a protective state, such as by deploying the barrier (by lowering it to protect a space), or both, to protect the interior of the room from external entry of projectiles (e.g., bullets), for example. Or the system may detect the entry of a ballistic projectile (e.g., a bullet, rock, etc.), or threatening shouts or yells, sirens, explosions, proximity of threatening individuals, etc., in which case the barrier would be activated into a protective mode.

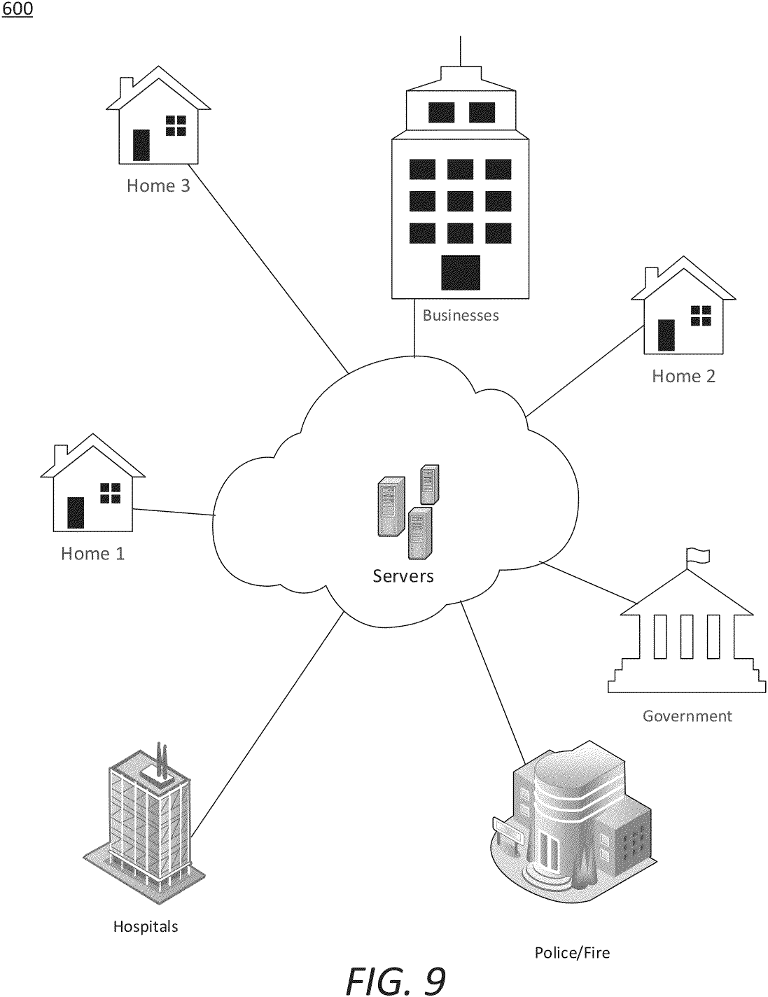

FIG. 9 shows an example networked neighborhood 600 where multiple homes, businesses, institutions, and safety forces are networked together to share information gathered by systems that can be installed in any, or all, of these locations. For example, a home under invasion can detect the invasion, and potentially broadcast a warning to neighbors, notify police, and in case of fire detection, notify the fire department. Hospitals may be notified if there are injured individuals detected, and government agencies may be notified for tracking and statistical analysis, and for long-term response and legislation and policies, for example. Businesses might be notified of the performance and status of their various products.

Furthermore, individuals (e.g., relatives, stakeholders, officials) located more remotely anywhere in the country or even in the world may be notified where desired. Individuals who are not home during a break-in can have their smart phones notified, and be provided video information, for example. Friends or relatives can be notified of problems, injuries, health emergencies, etc. These systems can be used to monitor medical conditions of individuals in the home or in hospitals or other care facilities. Security personnel can be notified of situations that they must respond to. In this way, all interested parties can be kept apprised of events that impact them.

When these systems are installed in homes, businesses, or other locations, constant monitoring of background noise and appliances, and other devices or people can be used to detect anomalies, such as impending product or appliance failures, gas and electric system status, weather conditions, etc. Remotely located relatives can monitor their elderly parents, siblings, grandparents, etc. The systems can monitor electrical power, water, natural gas, propane, internet, and other utility usage for detecting anomalies and other unusual circumstances, and to perform assessments and monitoring.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A system for protecting a space from entry by prohibited kinetic objects of substantial mass using a deployable barrier, comprising:
a deployable and retractable base structure configured to bar entry into the space when deployed;
a deployable and retractable anti-ballistic barrier configured to be deployed adjacent to said base structure to provide anti-ballistic protection to the space, said anti-ballistic barrier structure comprised of a plurality of layers of flexible anti-ballistic material laminated together.

2. The system of claim 1, further comprising a deployment structure configured for deploying said anti-ballistic barrier and further configured for retracting and storing the anti-ballistic barrier in a retracted position.

3. The system of claim 2, wherein said deployment structure is further configured for deploying said base structure and still further configured for retracting and storing the base structure in a retracted position.

4. The system of claim 3, wherein said anti-ballistic barrier is at least partially attached to the base structure when both said anti-ballistic barrier and the base structure are deployed.

5. The system of claim 4, wherein said anti-ballistic barrier and the base structure are deployed together.

6. The system of claim 1, further comprising a deployment structure configured for deploying said base structure and further configured for retracting and storing the base structure in a retracted position.

7. The system of claim 1, further comprising:
a first deployment structure configured for deploying said base structure and further configured for retracting and storing the base structure in a retracted position; and
a second deployment structure configured for deploying said anti-ballistic barrier and further configured for retracting and storing the anti-ballistic barrier in a retracted position, wherein
said base structure and said anti-ballistic barrier can be independently deployed.

8. The system of claim 1, further comprising:
a sensing system for detecting threat data indicating a kinetic object threat exists; and
a control system configured to receive said threat data from said sensing system, said control system operably configured to automatically deploy said anti-ballistic barrier into the deployed position based on the received threat data.

9. The system according to claim 8, wherein to automatically deploy said barrier into the deployed position includes activating or deactivating an electromagnet.

11. The system of claim 1, wherein said barrier is configured to flex and move in response to impact from the kinetic object to absorb energy from the kinetic object to further protect said space from access by the ballistic object.

12. The system according to claim 1, wherein said flexible anti-ballistic material includes a synthetic fiber of high tensile strength.

13. The system according to claim 1, wherein said flexible anti-ballistic material includes a fabric treated with boron.

14. The system according to claim 1, wherein said flexible anti-ballistic material includes an ultrahigh molecular weight polyethylene.

15. The system according to claim 1, wherein said flexible anti-ballistic material includes a transparent polycarbonate of high impact strength.

16. The system according to claim 1, wherein said barrier is attached to an existing deployable door, and wherein said deployment mechanism is part of said existing door.

17. The system according to claim 1, wherein said base structure is comprised in a retractable door.

18. The system according to claim 1, further comprising:
a sensing system for detecting threat data indicating a ballistic threat exists; and
a control system configured to receive said threat data from said sensing system, said control system operably configured to trigger said deployment mechanism to automatically deploy said barrier in a manner that secures sides and/or a bottom of said barrier to a wall and/or a floor, respectively.

19. The system according to claim 18, wherein said barrier is secured to the wall and/or the floor using a magnet and/or electromagnet.

20. The system according to claim 18, wherein said barrier is secured to the floor using a latching mechanism.

21. The system according to claim 1, wherein deploying the barrier into the deployed position is activated by a security system.

22. The system according to claim 1, wherein said flexible anti-ballistic material comprises a laminate including more than two layers of flexible anti-ballistic material.

23. The system according to claim 16, wherein the layers of said anti-ballistic laminate are secured together by stitching.

24. The system of claim 1, wherein said kinetic object is a vehicle.

25. The system of claim 1, further comprising a deployment mechanism configured to drop the deployable barrier into the deployed position such that the barrier protects the space from entry by prohibited kinetic objects having substantial kinetic energy.

26. The system of claim 1, wherein said barrier is configured to flex and move in response to impact from the kinetic object to absorb energy from the kinetic object to further protect said space from access by the ballistic object.

27. The system according to claim 1, wherein said barrier is attached to an existing deployable door, and wherein said deployment mechanism is part of said existing door.
